(19) United States
(12) Patent Application Publication
(10) Pub. No.: US 2001/0010792 A1
(43) Pub. Date: Aug. 2, 2001

(54) Book publishing

(75) Inventors: Barrie John Henderson, Woodlands (GB); Simon Peter Couchman, Grove Gardens (GB)

Correspondence Address: Kenneth Solomon, HOWELL & HAFERKAMP, L.C., 7733 Forsyth Boulevard, Suite 1400, St. Louis, MO, 63105, US

(73) Assignee: Top That Publication plc

(21) Appl. No.: 09/771,199

(22) Filed: Jan. 26, 2001

(30) Foreign Application Priority Data
Feb. 1, 2000 (GB) 0002158.4

(51) Int. Cl. B42B 2/00

(52) U.S. Cl. 412/1; 412/3; 412/5; 283/36

(57) ABSTRACT

A loose-leaf book, published with the pages collected in a binder, is updated by publishing new pages for the book on the internet, having users download those pages and then punch or otherwise modify the downloaded pages so that they fit in the binder and conform to the format of the existing pages.

This invention relates to book publishing and in particular to a method of updating a published loose-leaf book.

Loose-leaf books are generally updated by the issue of printed pages by the book publisher, these pages being distributed as physical pages in the correct size and punched formats to subscribers, through conventional mail channels.

Much information is published and updated on the internet. One particular feature of internet publishing is that it is easy to keep the published matter up to date for any person who accesses the published matter in this way. On the other hand, printed material is often easier to access, as it does not require the user to have access to a computer terminal connected to the internet at the time of access.

According to the invention, there is provided a method of publishing a book, comprising the steps of providing a loose-leaf binder for accepting a binder print format size smaller than any established computer print format, publishing pages on the internet in said binder print format size, making those pages available for downloading onto an established computer print format with printed markings indicating the boundaries of the binder print format size, trimming the pages to the printed markings, punching the pages to fit in the binder, and filing the pages in the binder.

Publishing pages on the internet has substantial benefits for the publisher in reducing costs. Users can select which pages they want to download, thus enabling each user to only print out relevant subject matter and avoiding wastage of paper and distribution costs. However the user will have a printed book which can be carried around and the information therein can be accessed without the need for a computer terminal.

The binder format may be a standard personal organiser format, which requires a row of binder holes to be punched. Punches for punching a row of holes in this way are commercially available.

The page content may be business or professional information, literature, entertainment or any other nature.

The binder may have sections for different information, and these sections can be separated by tabbed divider leaves. The pages may be coded to assist the user in filing them in the correct part of the binder. This coding may be done using colour, or alphanumeric characters.

The internet website from which the pages can be downloaded may have different pages where updates for different books can be found. Purchasers of the books can sign on at the publisher's web site to be informed electronically by email when new pages are available on the website for downloading.

The invention will now be further described, by way of example, with reference to the accompanying drawings, in which:

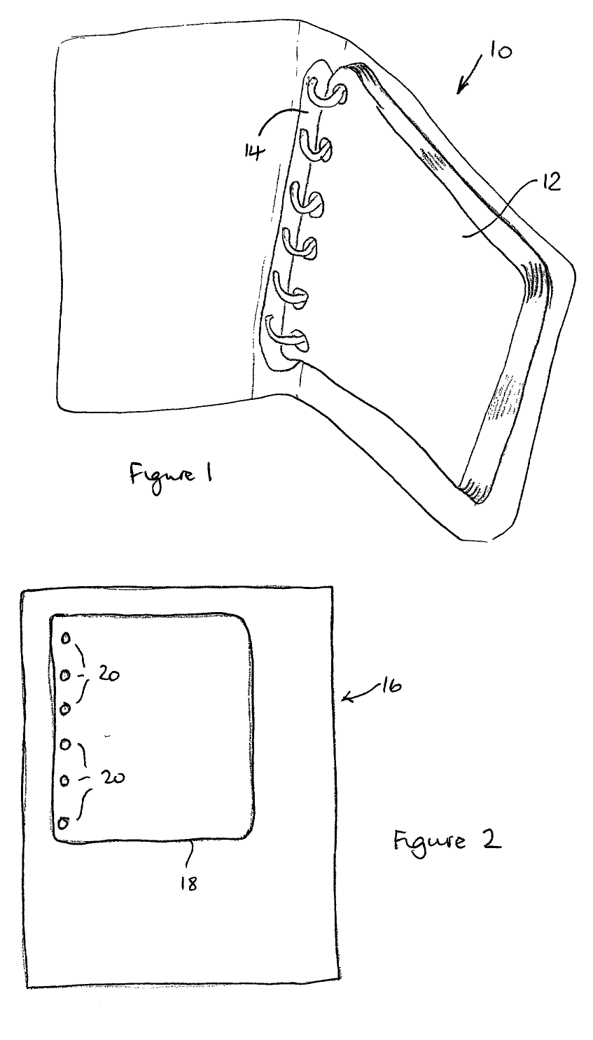

FIG. 1 shows a book of a format with which the inventive method can be applied; and

FIG. 2 shows a page downloaded from the internet and printed out, prior to modification to fit the binder.

FIG. 1 shows a binder 10 with a conventional openable ring system 14 for holding punched pages 12 which can be held in the binder and turned over so that each page can be read.

The binder is a six-ring format as commonly used for personal organisers.

FIG. 2 shows a page 16 which is a standard size page (eg A4 or Letter format), which is commonly accepted by standard computer printers. The page 16 has had information printed on it, the information having been previously downloaded from the internet. The information is printed within an area bounded by a line 18, this line corresponding to the size of the pages 12 in the binder 10.

Having printed out this page, the user then cuts the page 16 along the line 18, and uses a punch to punch an array of holes 20 so that the page can fit into the binder 10, in a uniform format with the pages 12 already there.

The page may also have information printed outside the line 18, for example instructions as to how to prepare the page to fit into the binder, or other non-permanent information.

1. A method of updating a loose-leaf book which has been published in a loose-leaf binder, comprising the steps of publishing pages on the internet, making those pages available for downloading onto paper, punching the paper pages to fit in the binder, and filing the pages in the binder.

2. A method of publishing a book, comprising the steps of providing a loose-leaf binder for accepting a binder print format size smaller than any established computer print format, publishing pages on the internet in said binder print format size, making those pages available for downloading onto an established computer print format with printed markings indicating the boundaries of the binder print format size, trimming the pages to the printed markings, punching the pages to fit in the binder, and filing the pages in the binder.

3. A method as claimed in claim 2, wherein the binder print format size is smaller than A4.

4. A method as claimed in claim 1, wherein the binder is a personal organiser binder with a row of six binder rings.

5. A method as claimed in claim 2, wherein the binder is a personal organiser binder with a row of six binder rings.

6. A method as claimed in claim 1, wherein the binder includes dividers to separate the binder contents into different sections.

7. A method as claimed in claim 2, wherein the binder includes dividers to separate the binder contents into different sections.
